(19) United States
(12) Patent Application Publication
(10) Pub. No.: US 2026/0056833 A1
(43) Pub. Date: Feb. 26, 2026

(54) ERROR CORRECTION DEVICE FOR CORRECTING 1-BIT ERROR OF TARGET DATA AND OPERATING METHOD THEREOF

(71) Applicant: SK hynix Inc., Icheon-si (KR)

(72) Inventors: Nam Shik Kim, Icheon-si (KR); Hoon Cho, Icheon-si (KR)

(21) Appl. No.: 19/002,235

(22) Filed: Dec. 26, 2024

(30) Foreign Application Priority Data
Aug. 26, 2024 (KR) 10-2024-0113966

(51) Int. Cl. G06F 11/10

(52) U.S. Cl. CPC G06F 11/1016; G06F 11/1004; G06F 11/1068

(57) ABSTRACT

An error correction device may calculate a syndrome S for target data on the basis of a first matrix M and a second matrix Q which are determined according to a preset cyclic redundancy check polynomial, may determine, on the basis of the syndrome S, whether an error has occurred in the target data, and when it is determined that an error has occurred in the target data, may search for an error data unit in which a 1-bit error has occurred among N number of data units on the basis of Hamming weights of error vectors for the N number of data units.

### CROSS-REFERENCE TO RELATED APPLICATION

The present application claims priority under 35 U.S.C. § 119 (a) to Korean Patent Application No. 10-2024-0113966 filed in the Korean Intellectual Property Office on Aug. 26, 2024, which is incorporated herein by reference in its entirety.

### BACKGROUND

### 1. Technical Field

Embodiments of the present disclosure relate to an error correction device for correcting a 1-bit error of target data and an operating method thereof.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

The storage device may execute a cyclic redundancy check (CRC) after reading data stored in the memory to determine whether an error has occurred in the read data.

Generally, when an error occurs in the read data, the storage device re-reads data. However, when a 1-bit error occurs in the read data, the storage device may correct the error without re-reading data.

### SUMMARY

Various embodiments of the present disclosure are directed to providing an error correction device which is capable of, when a 1-bit error occurs in data, quickly detecting a portion where the error has occurred and quickly correcting the error, and an operating method thereof.

In an aspect, an error correction device may include: i) a memory unit configured to store target data including N number of data units, each data unit having a size of L bits; and ii) a calculation circuit configured to calculate a syndrome S for the target data on the basis of a first matrix M and a second matrix Q which are determined according to a preset cyclic redundancy check polynomial, determine, on the basis of the syndrome S, whether an error has occurred in the target data, and in response to determining that an error has occurred in the target data, search for an error data unit in which a 1-bit error has occurred among the N number of data units on the basis of the Hamming weights of error vectors for the N number of data units.

In another aspect, an error correction method may include: i) calculating a syndrome S on the basis of a first matrix M and a second matrix Q determined according to a preset cyclic redundancy check polynomial for target data including N number of data units each having a size of L bits; ii) determining whether an error has occurred in the target data on the basis of the syndrome S; and iii) in response to determining that an error has occurred in the target data, searching for an error data unit in which a 1-bit error has occurred among the N number of data units on the basis of the Hamming weights of error vectors for the N number of data units.

According to the embodiments of the present disclosure, when a 1-bit error occurs in data, a portion where the error has occurred may be quickly detected and the error may be quickly corrected.

### BRIEF DESCRIPTION OF THE DRAWINGS

FIG. 1 is a schematic configuration diagram of a storage device according to an embodiment of the present disclosure.

FIG. 2 is a block diagram schematically illustrating a memory of FIG. 1.

FIG. 3 is a diagram illustrating an example of the structure of an error correction device according to embodiments of the present disclosure.

FIG. 4 is a flowchart illustrating an example of the operation of the error correction device according to embodiments of the present disclosure.

FIG. 5 is a flowchart illustrating an operation in which the error correction device according to embodiments of the present disclosure determines whether an error has occurred in target data.

FIG. 6 is a flowchart illustrating an operation in which the error correction device according to embodiments of the present disclosure searches for an error data unit.

FIG. 7 is a diagram illustrating another example of the structure of the error correction device according to embodiments of the present disclosure.

FIG. 8 is a diagram illustrating the calculation of an error vector output circuit according to embodiments of the present disclosure.

FIG. 9 is a diagram illustrating an error correction method according to embodiments of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present disclosure are described below in more detail with reference to the accompanying drawings. However, the present disclosure may be embodied in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other non-transitory computer-readable storage device for storing code or instructions to be executed, for example, by a computer, processor, microprocessor, controller, or other signal processing device.

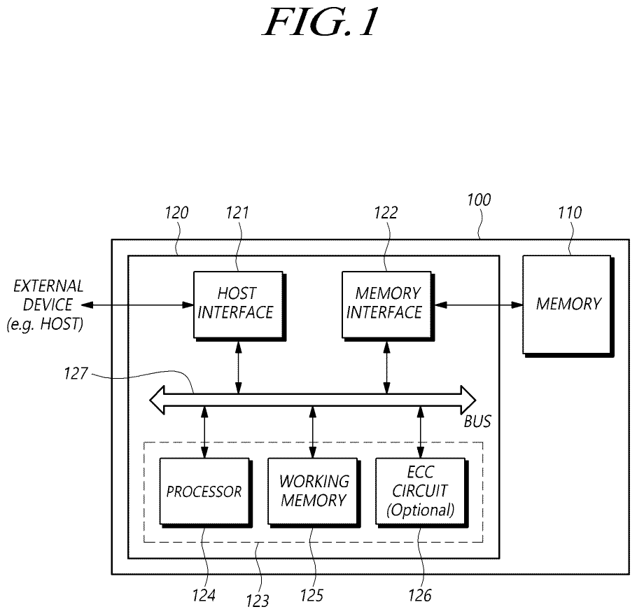

FIG. 1 is a schematic configuration diagram of a storage device 100 according to an embodiment of the disclosure.

Referring to FIG. 1, the storage device 100 may include a memory 110 that stores data and a controller 120 that controls the memory 110.

The memory 110 includes a plurality of memory blocks, and operates in response to the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g. SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

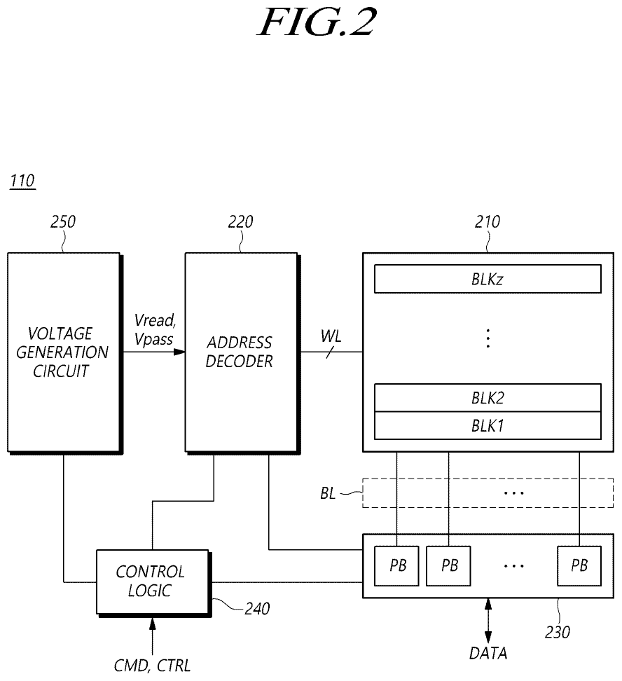

Hereinbelow, the memory 110 will be described in further detail with reference to FIG. 2.

FIG. 2 is a block diagram schematically illustrating a memory 110 of FIG. 1.

Referring to FIG. 2, the memory 110 according to an embodiment of the disclosure may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an illustrative embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

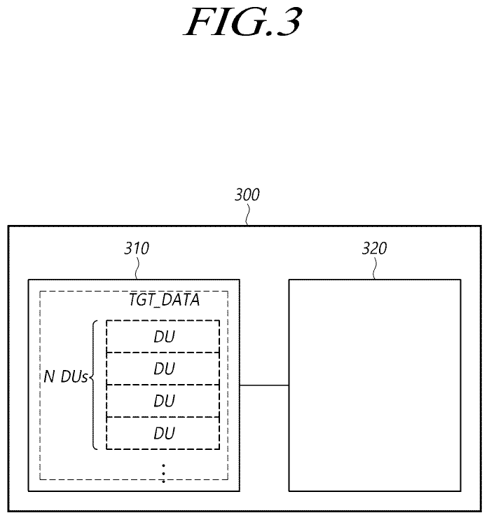

FIG. 3 is a diagram illustrating an example of the structure of an error correction device 300 according to embodiments of the present disclosure.

Referring to FIG. 3, the error correction device 300 may include a memory unit 310 and a calculation circuit 320.

The memory unit 310 may store target data TGT_DATA which includes N (N is a natural number of 2 or more) number of data units DU. The size of each data unit DU may be L (L is a natural number of 2 or more) bits.

In the embodiments of the present disclosure, an order may be defined for the N number of data units DU. For example, the N number of data units DU may be defined with an order from a first data unit DU to an Nth data unit DU according to a read order or address values.

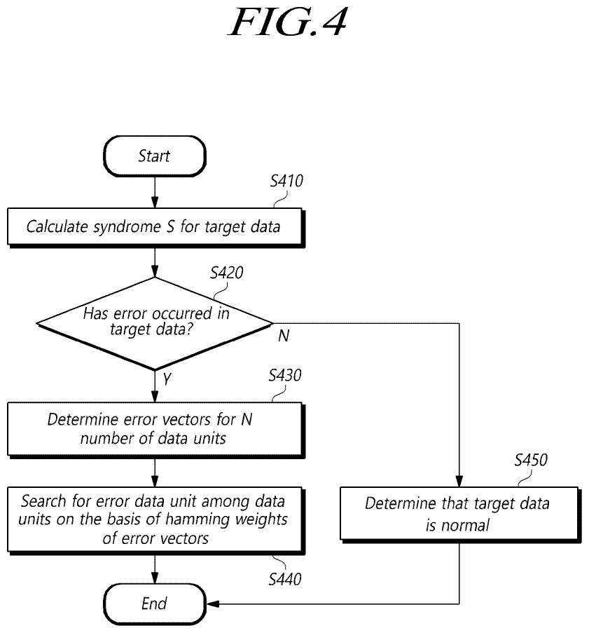

The calculation circuit 320 may search for an error data unit in which a 1-bit error has occurred among the N number of data units DU included in the target data TGT_DATA. This will be described in detail with reference to FIG. 4.

The error correction device 300 may be implemented in various ways.

For example, the error correction device 300 may be implemented by the storage device 100 described above with reference to FIG. 1. At this time, the memory unit 310 may be implemented by the memory 110 included in the storage device 100, and the calculation circuit 320 may be implemented by the controller 120 included in the storage device 100.

For another example, the error correction device 300 may be implemented by an integrated circuit which includes logic gates for performing the operations described above. At this time, the memory unit 310 may be implemented by a plurality of modules (e.g., registers or memory cells) capable of storing data, and the calculation circuit 320 may be implemented by an application specific integrated circuit (ASIC) or a field programmable gate array (FPGA).

FIG. 4 is a flowchart illustrating an example of the operation of the error correction device 300 according to the embodiments of the present disclosure.

Referring to FIG. 4, the calculation circuit 320 of the error correction device 300 may calculate a syndrome S for the target data TGT_DATA (S410).

The calculation circuit 320 may calculate the syndrome S on the basis of a first matrix M and a second matrix Q which are determined according to a preset cyclic redundancy check (CRC) polynomial. When the size of each data unit DU is L bits, the first matrix M and the second matrix Q may be L*L matrices.

For example, the calculation circuit 320 may determine the syndrome S as follows.

First, the calculation circuit 320 may determine a seed matrix S1 corresponding to a first data unit among the N number of data units DU as a preset initial seed matrix. The seed matrix S1 may be used as S(1), that is, as S(t−1) when t=2, in Equation 1 below.

The calculation circuit 320 may determine a seed matrix S(t) corresponding to a t^{th} (t is a natural of 2 or more) data unit among the N number of data units DU as in Equation 1.

$$S ( t ) = MR ( t - 1 ) + QS ( t - 1 ) \qquad [ Equation 1 ]$$

R(t−1) may be a matrix whose elements are respective bits of a (t−1)th data unit among the N number of data units DU. R(t−1) may be composed of a 1*L matrix, and the value of an element located at an ith column of R(t−1) may be the value of an ith bit of the (t−1)th data unit.

The calculation circuit 320 may determine the syndrome S as MR (N)+QS(N).

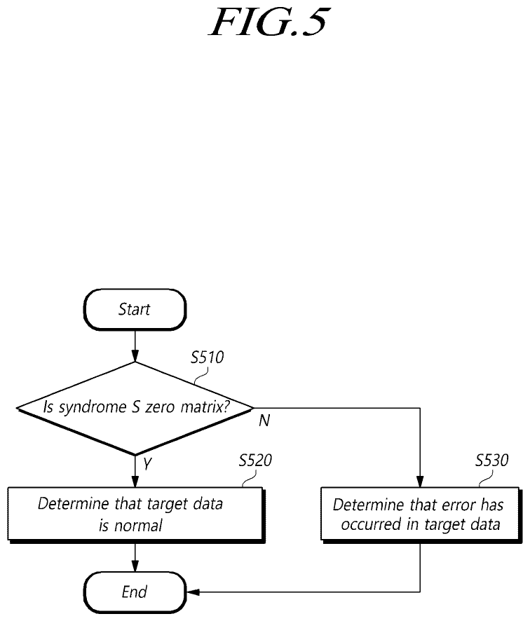

The calculation circuit 320 may determine whether an error has occurred in the target data TGT_DATA on the basis of the calculated syndrome S(S420). This will be described in detail with reference to FIG. 5.

When it is determined that an error has occurred in the target data TGT_DATA (S420-Y), the calculation circuit 320 may determine error vectors for the N number of data units DU (S430).

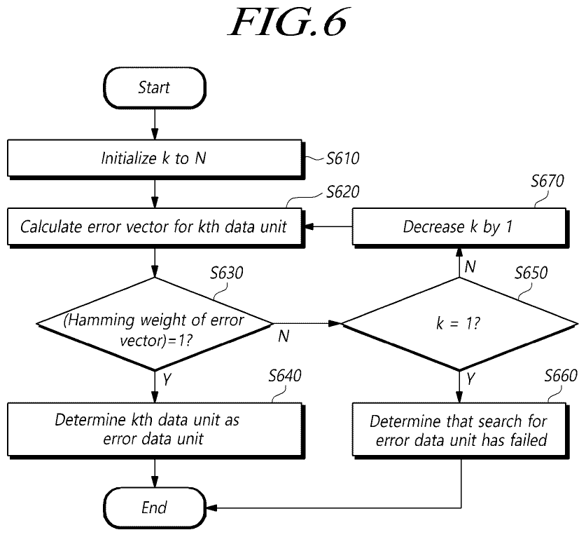

The calculation circuit 320 may search for an error data unit where a 1-bit error has occurred among the N number of data units DU, on the basis of the Hamming weights of the error vectors determined in the step S430 (S440). This will be described in detail with reference to FIG. 6.

On the other hand, when it is determined that an error has not occurred in the target data TGT_DATA (S420-N), the calculation circuit 320 may determine that the target data TGT_DATA is normal (S450). In this case, the calculation circuit 320 may not perform a separate error correction operation on the target data TGT_DATA.

FIG. 5 is a flowchart illustrating an operation in which the error correction device 300 according to the embodiments of the present disclosure determines whether an error has occurred in the target data TGT_DATA.

Referring to FIG. 5, the calculation circuit 320 of the error correction device 300 determines whether the calculated syndrome S is a zero matrix (S510).

When the syndrome S is a zero matrix (S510-Y), the calculation circuit 320 may determine that the target data TGT_DATA is normal (S520).

On the other hand, when the syndrome S is not a zero matrix (S510-N), the calculation circuit 320 may determine that an error has occurred in the target data TGT_DATA (S530).

Below, a specific operation in which the error correction device 300 searches for an error data unit is described.

In the embodiments of the present disclosure, the calculation circuit 320 of the error correction device 300 may search for an error data unit by traversing the N number of data units DU in a reverse order starting from the Nth data unit among the N number of data units DU. The calculation circuit 320 may execute search in the order of the Nth data unit, an (N-1)th data unit, an (N-2)th data unit, and so on.

That is to say, the calculation circuit 320 may determine whether the Nth data unit is an error data unit, may determine, when the Nth data unit is not an error data unit, whether the (N-1)th data unit is an error data unit, and may determine, when the (N-1)th data unit is not an error data unit, whether the (N-2)th data unit is an error data unit, and so on.

The calculation circuit 320 may perform such an operation until searching for an error data unit succeeds or whether a data unit is an error data unit is determined for all of the N number of data units.

FIG. 6 is a flowchart illustrating an operation in which the error correction device 300 according to the embodiments of the present disclosure searches for an error data unit.

Referring to FIG. 6, the calculation circuit 320 of the error correction device 300 may initialize k to N (S610), and may calculate an error vector Eₖ for a k^{th} (k is a natural number equal to or smaller than N) data unit among the N number of data units DU (620).

The error vector Eₖ for the k^{th} data unit among the N number of data units DU may be determined as in Equation 2 on the basis of the above-described syndrome S, the first matrix M, the second matrix Q and k.

$${E}_{k} = {M}^{- 1} {Q}^{( k - N )} S \qquad [ Equation 2 ]$$

In this case, when k=N, E_{N}=M⁻¹Q^{(N-N)} S=M⁻¹S, and when k=N−1, E_{N-1}=M⁻¹Q^{(N-1-N)} S=M⁻¹Q⁻¹S. In the same way, E₁=M⁻¹Q^{(1-N)} S=M⁻¹Q^{-N+1}S may be determined.

The calculation circuit 320 may determine whether the Hamming weight of the error vector Eₖ for the k^{th} data unit is 1 (S630). The calculation circuit 320 may determine the number of elements which are 1 among the elements of the error vector Eₖ, as the Hamming weight.

When the Hamming weight of the error vector Eₖ for the k^{th} data unit is 1 (S630-Y), the calculation circuit 320 may determine the k^{th} data unit as an error data unit (S640).

The calculation circuit 320 may correct the error data unit using the sum of the error vector Eₖ for the error data unit and a matrix whose elements are respective bits of the error data unit.

On the other hand, when the Hamming weight of the error vector Eₖ for the k^{th} data unit is not 1 (S630-N), the calculation circuit 320 determines whether k is 1 to determine whether to additionally search for an error data unit (S650).

When k is 1 (S650-Y), the calculation circuit 320 may determine that a search for an error data unit has failed (S660). This is because among the N number of data units DU, there exists no data unit in which the Hamming weight of an error vector is 1.

On the other hand, when k is not 1 (S650-N), the calculation circuit 320 may decrease k by 1 (S670) and may execute the step S620 again.

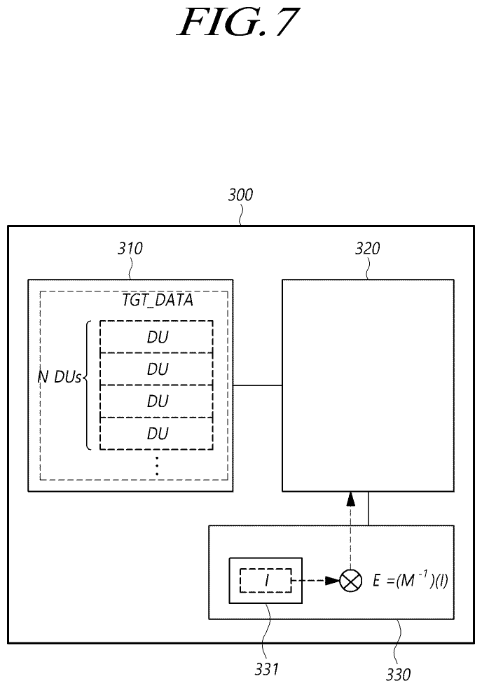

When an error vector is determined according to the above-described Equation 2, the error correction device 300 may additionally include a separate circuit for quickly calculating an error vector for each data unit. This will be described in detail with reference to FIG. 7.

FIG. 7 is a diagram illustrating another example of the structure of the error correction device 300 according to the embodiments of the present disclosure.

Referring to FIG. 7, the error correction device 300 may additionally include an error vector output circuit 330 in addition to the memory unit 310 and the calculation circuit 320 described above with reference to FIG. 3. In FIG. 7, a case where the error vector output circuit 330 is located outside the calculation circuit 320 is described as an example, but the error vector output circuit 330 may be located inside the calculation circuit 320.

The error vector output circuit 330 may include an input matrix storage section 331 which stores an input matrix I.

The error vector output circuit 330 may initialize the input matrix I to the syndrome S.

In the embodiments of the present disclosure, the error vector output circuit 330 may output the product of the input matrix I and the inverse matrix M-1 of the first matrix M as an error vector.

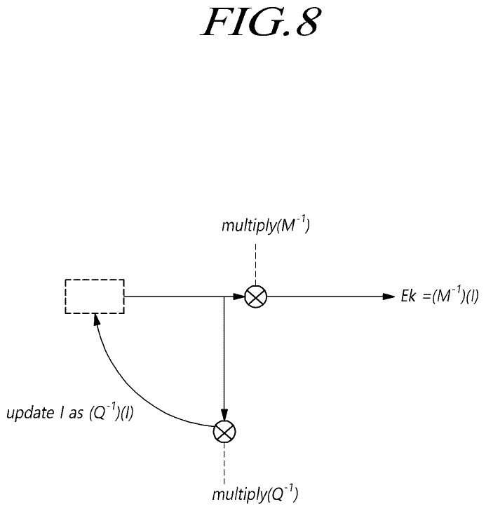

FIG. 8 is a diagram illustrating the calculation of the error vector output circuit 330 according to the embodiments of the present disclosure.

Referring to FIG. 8, the error vector output circuit 330 may output the product of the input matrix I and the inverse matrix M-1 of the first matrix M as an error vector.

Thereafter, the error vector output circuit 330 may update the input matrix I as the product (Q⁻¹) I of the input matrix I and the inverse matrix Q⁻¹ of the second matrix Q.

The reason why the error vector output circuit 330 operates in this way is as follows.

When an error vector is determined according to the above-described Equation 2, an error vector for the k^{th} data unit among the N number of data units DU is the product of an error vector for a (k+1)th data unit and the inverse matrix Q⁻¹ of the second matrix Q.

Therefore, instead of calculating the error vector for the k^{th} data unit from beginning, by using a result calculated in the process of previously determining the error vector for the (k+1)th data unit, the error vector for the k^{th} data unit may be determined more quickly.

Meanwhile, instead of updating the input matrix I, the error vector output circuit 330 may separately store an input matrix calculated for each data unit in the input matrix storage section 331.

For example, the error vector output circuit 330 may separately store an input matrix which is used when determining an error vector for the Nth data unit, an input matrix which is used when determining an error vector for the (N-1)th data unit, an input matrix which is used when determining an error vector for the (N-2)th data unit, etc., in the input matrix storage section 331.

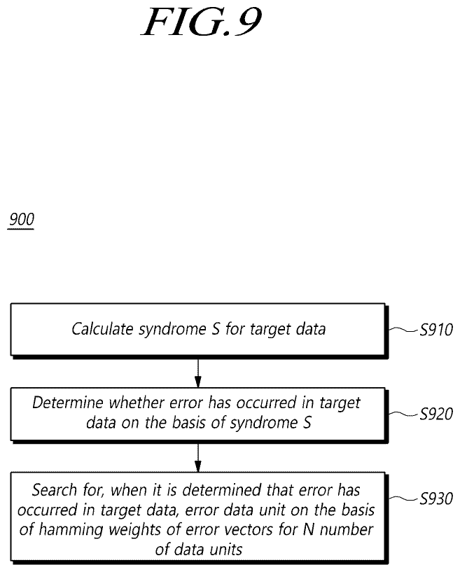

FIG. 9 is a diagram illustrating an error correction method 900 according to the embodiments of the present disclosure.

Referring to FIG. 9, the error correction method 900 may include step S910 of calculating a syndrome S on the basis of a first matrix M and a second matrix Q determined according to a preset cyclic redundancy check polynomial for target data TGT_DATA including N number of data units DU each having a size of L bits.

For example, the step S910 may determine a seed matrix S(1) corresponding to a first data unit among the N number of data units DU as a preset initial seed matrix, may determine a seed matrix S(t) corresponding to a t^{th} data unit among the N number of data units DU as S (t)=MR (t−1)+QS(t−1) on the basis of a matrix R(t−1) whose elements are respective bits of a (t−1)th data unit among the N number of data units DU, and may determine the syndrome S as MR (N)+QS(N).

The error correction method 900 may include step S920 of determining whether an error has occurred in the target data TGT_DATA on the basis of the syndrome S.

For example, the step S920 may determine that the target data TGT_DATA is normal when the syndrome S is a zero matrix, and may determine that an error has occurred in the target data TGT_DATA when the syndrome S is not a zero matrix.

The error correction method 900 may include step S930 of searching for, when it is determined that an error has occurred in the target data TGT_DATA, an error data unit in which a 1-bit error has occurred among the N number of data units DU on the basis of the Hamming weights of error vectors for the N number of data units DU.

For example, the step S930 may search for an error data unit by traversing the N number of data units DU in a reverse order starting from the Nth data unit among the N number of data units DU, until searching for an error data unit succeeds or whether a data unit is an error data unit is determined for all of the N number of data units.

An error vector Eₖ for a k^{th} data unit among the N number of data units DU may be determined as in the following equation on the basis of the syndrome S, a first matrix M, a second matrix Q and k.

$${E}_{k} = {M}^{- 1} {Q}^{( k - N )} S$$

When the Hamming weight of the error vector for the k^{th} data unit among the N number of data units is 1, the step S930 may determine the k^{th} data unit among the N number of data units as an error data unit.

In this case, the error correction method 900 may additionally include a step of correcting the error data unit using the sum of the error vector for the error data unit and a matrix whose elements are respective bits of the k^{th} data unit.

The error correction method 900 described with reference to FIG. 9 may be executed by the error correction device 300 described above.

Although illustrative embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. An error correction device comprising:
a memory unit configured to store target data including N number of data units, each data unit having a size of L bits; and
a calculation circuit configured to:
calculate a syndrome S for the target data on the basis of a first matrix M and a second matrix Q which are determined according to a preset cyclic redundancy check polynomial,
determine, on the basis of the syndrome S, whether an error has occurred in the target data, and
in response to determining that an error has occurred in the target data, search for an error data unit in which a 1-bit error has occurred among the N number of data units on the basis of the Hamming weights of error vectors for the N number of data units,
wherein N and L are natural numbers of 2 or more.

2. The error correction device according to claim 1,
wherein the calculation circuit:
determines a seed matrix S(1) corresponding to a first data unit among the N number of data units as a preset initial seed matrix,
determines a seed matrix S(t) corresponding to a t^{th} data unit among the N number of data units according to the following equation on the basis of a matrix R(t−1) whose elements are respective bits of a (t−1)th data unit among the N number of data units, and
$$S ( t ) = MR ( t - 1 ) + QS ( t - 1 )$$
determines the syndrome S as MR (N)+QS(N), and
wherein t is a natural number of 2 or more.

3. The error correction device according to claim 1, wherein the calculation circuit determines that the target data is normal when the syndrome S is a zero matrix, and determines that an error has occurred in the target data when the syndrome S is not the zero matrix.

4. The error correction device according to claim 1, wherein the calculation circuit searches for the error data unit by traversing the N number of data units in a reverse order starting from an Nth data unit among the N number of data units, until searching for the error data unit succeeds or whether each data unit is an error data unit is determined for all of the N number of data units.

5. The error correction device according to claim 4,
wherein the calculation circuit determines an error vector Eₖ for a k^{th} data unit among the N number of data units as in the following equation on the basis of the syndrome S, the first matrix M, the second matrix Q and k, and
$${E}_{k} = {M}^{- 1} {Q}^{( k - N )} S$$
wherein k is a natural number equal to or smaller than N.

6. The error correction device according to claim 5, wherein when the Hamming weight of the error vector for the k^{th} data unit among the N number of data units is 1, the calculation circuit determines the k^{th} data unit among the N number of data units as an error data unit.

7. The error correction device according to claim 6, wherein the calculation circuit corrects the error data unit using the sum of the error vector for the error data unit and a matrix whose elements are respective bits of the k^{th} data unit.

8. The error correction device according to claim 5, further comprising:
an error vector output circuit configured to output the error vector for the k^{th} data unit among the N number of data units,
wherein the error vector output circuit includes an input matrix storage section which stores an input matrix, and outputs the product of the input matrix and an inverse matrix of the first matrix M as the error vector.

9. The error correction device according to claim 8, wherein the error vector output circuit initializes the input matrix to the syndrome S.

10. The error correction device according to claim 8, wherein after outputting the product of the input matrix and the inverse matrix of the first matrix M, the error vector output circuit updates the input matrix with the product of the input matrix and an inverse matrix of the second matrix Q.

11. An error correction method comprising:
calculating a syndrome S on the basis of a first matrix M and a second matrix Q determined according to a preset cyclic redundancy check polynomial for target data including N number of data units each having a size of L bits;
determining whether an error has occurred in the target data on the basis of the syndrome S; and
in response to determining that an error has occurred in the target data, searching for an error data unit in which a 1-bit error has occurred among the N number of data units on the basis of the Hamming weights of error vectors for the N number of data units,
wherein N and L are natural numbers of 2 or more.

12. The error correction method according to claim 11,
wherein calculating the syndrome S comprises:
determining a seed matrix S(1) corresponding to a first data unit among the N number of data units as a preset initial seed matrix,
determining a seed matrix S(t) corresponding to a t^{th} data unit among the N number of data units according to the following equation on the basis of a matrix R(t−1) whose elements are respective bits of a (t−1)th data unit among the N number of data units, and
$$S ( t ) = MR ( t - 1 ) + QS ( t - 1 )$$
determining the syndrome S as MR (N)+QS(N), and
wherein t is a natural number of 2 or more.

13. The error correction method according to claim 11, wherein whether an error has occurred in the target data comprises determining that the target data is normal when the syndrome S is a zero matrix, and
determining that an error has occurred in the target data when the syndrome S is not a zero matrix.

14. The error correction method according to claim 11, wherein searching for an error data unit comprises searching for the error data unit by traversing the N number of data units in a reverse order starting from an Nth data unit among the N number of data units, until searching for the error data unit succeeds or whether each data unit is an error data unit is determined for all of the N number of data units.

15. The error correction method according to claim 14,
wherein searching for an error data unit comprises determining an error vector Eₖ for a k^{th} data unit among the N number of data units as in the following equation on the basis of the syndrome S, the first matrix M, the second matrix Q and k, and
$${E}_{k} = {M}^{- 1} {Q}^{( k - N )} S$$
wherein k is a natural number equal to or smaller than N.

16. The error correction method according to claim 15, wherein searching for an error data unit comprises when the Hamming weight of the error vector for the k^{th} data unit among the N number of data units is 1, determining the k^{th} data unit among the N number of data units as an error data unit.

17. The error correction method according to claim 16, further comprising:
correcting the error data unit using the sum of the error vector for the error data unit and a matrix whose elements are respective bits of the k^{th} data unit.
